(19) United States
(12) Patent Application Publication
(10) Pub. No.: US 2009/0185881 A1
(43) Pub. Date: Jul. 23, 2009

(54) RIVET, AND HANGING HOOK HAVING THE SAME

(76) Inventor: Rong-Der Hong, Taichung (TW)

Correspondence Address: CHRISTIE, PARKER & HALE, LLP, PO BOX 7068, PASADENA, CA, 91109-7068, US

(21) Appl. No.: 12/121,612

(22) Filed: May 15, 2008

(30) Foreign Application Priority Data
Jan. 22, 2008 (TW) 097201374

(51) Int. Cl. F16B 19/04

(52) U.S. Cl. 411/501

(57) ABSTRACT

A rivet includes a main body having a rod portion connected integrally to an enlarged head portion and extending through first and second members. An end portion of the rod portion extends outwardly of an assembly of the first and second members, and has a thinner section interconnecting thicker and frusto-conical sections. A diameter of the frusto-conical section is smaller than that of the thicker section, is not smaller than that of the thinner section, and decreases gradually toward the thinner section. A cover body is sleeved fittingly on the end portion of the rod portion, and has a through hole permitting extension of the end portion of the rod portion therethrough so that the frusto-conical section of the end portion covers the through hole in the cover body, thereby positioning the cover body on the assembly of the first and second members.

### CROSS-REFERENCE TO RELATED APPLICATION

This application claims priority of Taiwanese Application No. 097201374, filed on Jan. 22, 2008.

### BACKGROUND OF THE INVENTION

1. Field of the Invention

The invention relates to a rivet, more particularly to a rivet for a hanging hook.

2. Description of the Related Art

FIG. 1 illustrates a conventional hanging hook 2 that includes a hook body 201, a first pivot member 202 connected pivotally to the hook body 201 by a rivet 1, and a second pivot member 203 having one end connected pivotally to the hook body 201 by another rivet 1, and the other end engaging releasably an end of the first pivot member 202. In this case, the first pivot member 202 serves as a latch for blocking an opening in the hook body 201. The second pivot member 203 serves as a locking piece, and is operable so as to switch between an unlocking state, where the other end of the second pivot member 203 disengages the end of the first pivot member 202 such that the first pivot member 202 is rotatable relative to the hook body 201 about the rivet 1, and a locking state, where the other end of the second pivot member 203 engages the end of the first pivot member 202 such that rotation of the first pivot member 202 is inhibited.

During assembly, for each rivet 1, a rod portion 102 connected integrally to an enlarged head portion 101 extends through a corresponding one of the first and second pivot members 202, 203 and the hook body 201 so that an end 1021 of the rod portion 102 extends outwardly of the corresponding one of the first and second pivot members 202, 203, as shown in FIG. 2. Then, the end 1021 of the rod portion 102 is pressed to form another head portion 103, as shown in FIG. 3, thereby connecting pivotally the corresponding one of the first and second pivot members 202, 203 to the hook body 201. Generally, the rod portion 102 of each rivet 1 has a certain hardness. Thus, during pressing of the end of the rod portion 102 of each rivet 1, the rod portion 102 of each rivet 1 becomes curved as a result of an excessive pressing force (see FIG. 3), thereby adversely influencing rotation of the corresponding one of the first and second pivot member 202, 203.

### SUMMARY OF THE INVENTION

Therefore, the object of the present invention is to provide a rivet, and a hanging hook having the same that can overcome the aforesaid drawbacks of the prior art.

According to one aspect of the present invention, there is provided a rivet for connecting pivotally a first member to a second member. The rivet comprises:

a main body having an enlarged head portion, and a rod portion connected integrally to the head portion and adapted to extend through the first and second members, the rod portion having an end portion adapted to extend outwardly of an assembly of the first and second members, the end portion of the rod portion having a thicker section disposed at an end thereof proximate to the head portion, a frusto-conical section disposed at an opposite end thereof, and a thinner section interconnecting the thicker and frusto-conical sections, the thicker section of the end portion of the rod portion having a diameter larger than those of the frusto-conical and thinner sections of the end portion of the rod portion, the diameter of the frusto-conical section of the end portion of the rod portion being not smaller than the thinner section of the end portion of the rod portion and decreasing gradually toward the thinner section of the end portion of the rod portion; and

a cover body sleeved fittingly on the end portion of the rod portion of the main body and formed with a through hole permitting extension of the end portion of the rod portion of the main body therethrough so that the frusto-conical section of the end portion of the rod portion of the main body covers the through hole in the cover body, thereby positioning the cover body on the assembly of the first and second members.

According to another aspect of the present invention, a hanging hook comprises:

a hook body;

a pivot member; and

a rivet for connecting pivotally the pivot member to the hook body so that the pivot member is pivotable relative to the hook body, the rivet including

a main body having an enlarged head portion, and a rod portion connected integrally to the head portion and extending through the hook body and the pivot member, the rod portion having an end portion extending outwardly of an assembly of the hook body and the pivot member, the end portion of the rod portion having a thicker section disposed at one end thereof proximate to the head portion, a frusto-conical section disposed at an opposite end thereof, and a thinner section interconnecting the thicker and frusto-conical sections, the thicker section of the end portion of the rod portion having a diameter larger than those of the frusto-conical and thinner sections of the end portion of the rod portion, the diameter of the frusto-conical section of the end portion of the rod portion being not smaller than the thinner section of the end portion of the rod portion and decreasing gradually toward the thinner section of the end portion of the rod portion, and

a cover body sleeved fittingly on the end portion of the rod portion of the main body and formed with a through hole permitting extension of the end portion of the rod portion of the main body therethrough so that the frusto-conical section of the end portion of the rod portion of the main body covers the through hole in the cover body, thereby positioning the cover body on the assembly of the hook body and the pivot member.

### BRIEF DESCRIPTION OF THE DRAWINGS

Other features and advantages of the present invention will be come apparent in the following detailed description of the preferred embodiment with reference to the accompanying drawings, of which:

FIG. 1 is a perspective view of a conventional hanging hook;

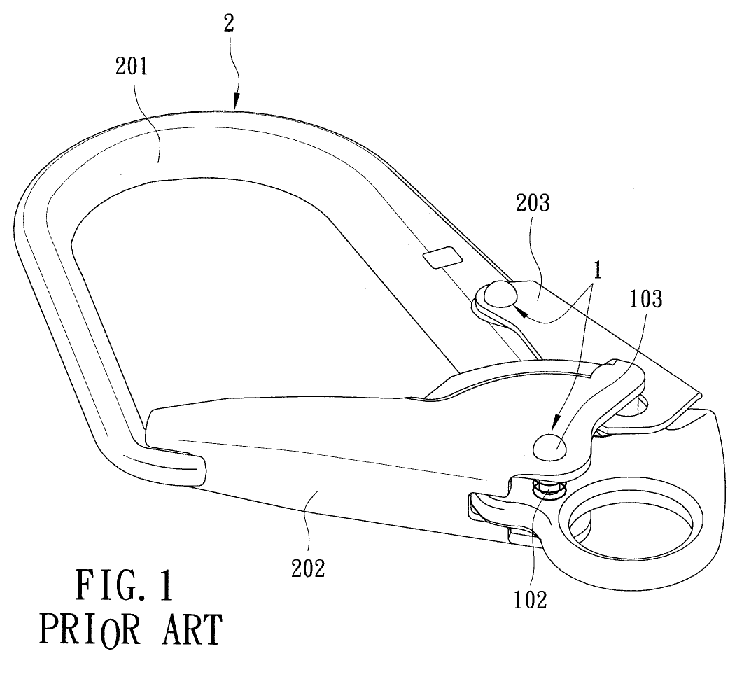

FIG. 2 is a fragmentary partly schematic sectional view showing a rivet of the conventional hanging hook prior to pressing;

FIG. 3 is a fragmentary partly sectional view illustrating the rivet of the conventional hanging hook with deformation caused by pressing;

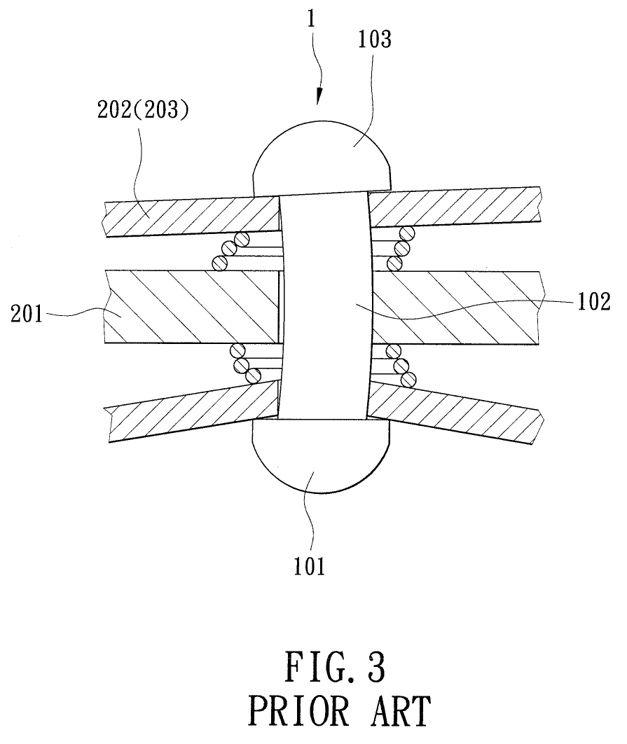

FIG. 4 is a perspective view showing the preferred embodiment of a hanging hook according to the present invention;

FIG. 5 is a fragmentary partly schematic sectional view showing a rivet of the preferred embodiment prior to pressing; and

FIG. 6 is a fragmentary partly schematic sectional view showing the rivet of the preferred embodiment after pressing.

### DETAILED DESCRIPTION OF THE PREFERRED EMBODIMENT

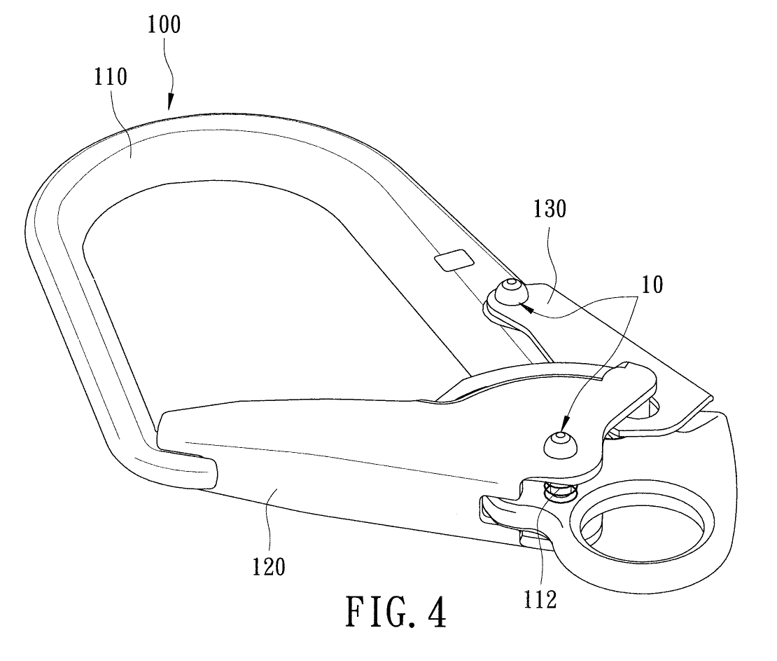

Referring to FIG. 4, the preferred embodiment of a hanging hook 100 according to the present invention is shown to include a hook body 110, a first pivot member 120 connected pivotally to the hook body 110 by a rivet 10, and a second pivot member 130 having one end connected pivotally to the hook body 110 by another rivet 10, and the other end engaging releasably an end of the first pivot member 120. In this case, the first pivot member 120 serves as a latch for blocking an opening in the hook body 110. The second pivot member 130 serves as a locking piece, and is operable so as to switch between an unlocking state, where the other end of the second pivot member 130 disengages the end of the first pivot member 120 such that the first pivot member 120 is rotatable relative to the hook body 110 about the corresponding rivet 1, and a locking state, where the other end of the second pivot member 130 engages the end of the first pivot member 120 such that rotation of the first pivot member 120 is inhibited.

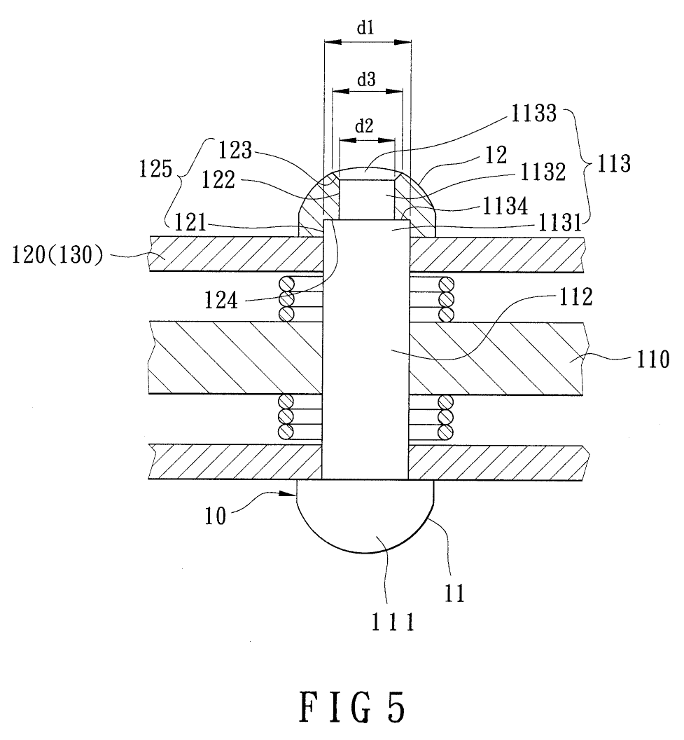

Referring further to FIG. 5, each rivet 10 includes a main body 11 and a cover body 12. For each rivet 10, the main body 11 has an enlarged head portion 111, and a rod portion 112 connected integrally to the head portion 111 and extending through a corresponding one of the first and second pivot members 120, 130, and the hook body 110. The rod portion of the main body 11 of each rivet 10 has an end portion 113 that extends outwardly of the corresponding one of the first and second pivot members 120, 130 and that has a thicker section 1131 disposed at an end thereof proximate to the head portion 111 of the corresponding rivet 10, a frusto-conical section 1133 disposed at an opposite end thereof, a thinner section 1132 interconnecting the thicker and frusto-conical sections 1131, 1133, and an outer annular shoulder surface 1134 disposed between the thicker and thinner sections 1131, 1132. For the main body 11 of each rivet 10, the thicker section 1131 of the end portion 113 of the rod portion 112 has a diameter (d1) larger than a diameter (d2) of the thinner section 1132 of the end portion 113 of the rod portion 112. The frusto-conical section 1133 of the end portion 113 of the rod portion 112 has a diameter ranging from d2 to d3, where d3<d1, and decreasing gradually toward the thinner section 1132 of the end portion 113 of the rod portion 112.

For each rivet 10, the cover body 12 is sleeved fittingly on the end portion 113 of the rod portion 112 of the main body 11, and is formed with a through hole 125 permitting extension of the end portion 113 of the rod portion 112 of the main body 11 therethrough so that the frusto-conical section 1133 of the end portion 113 of the rod portion 112 covers the through hole 125 in the cover body 12, thereby positioning the cover body 12 on the corresponding one of the first and second pivot members 120, 130. In this embodiment, for each rivet 10, the through hole 125 in the cover body 12 has a wider portion 121 for receiving fittingly the thicker section 1131 of the end portion 113 of the rod portion 112 of the main body 11, a narrower portion 122 for receiving fittingly the thinner section 1132 of the end portion 113 of the rod portion 112 of the main body 11, and a frusto-conical portion 123 for receiving fittingly the frusto-conical section 1133 of the end portion 113 of the rod portion 112 of the main body 11. The cover body 12 of each rivet 10 has an inner annular shoulder surface 124 disposed between the wider and narrower portions 121, 122 of the through hole 125 and abutting against the outer annular shoulder surface 1134 of the end portion 113 of the rod portion 112 of the main body 11 of the corresponding rivet 10.

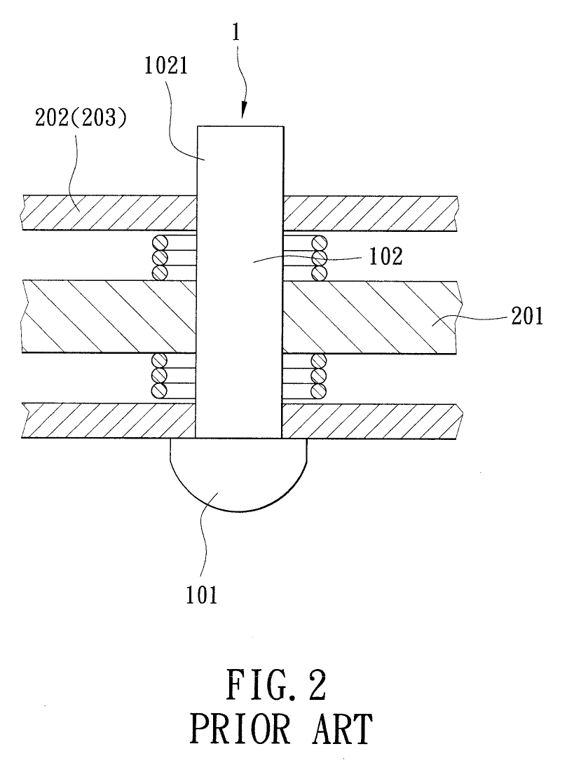

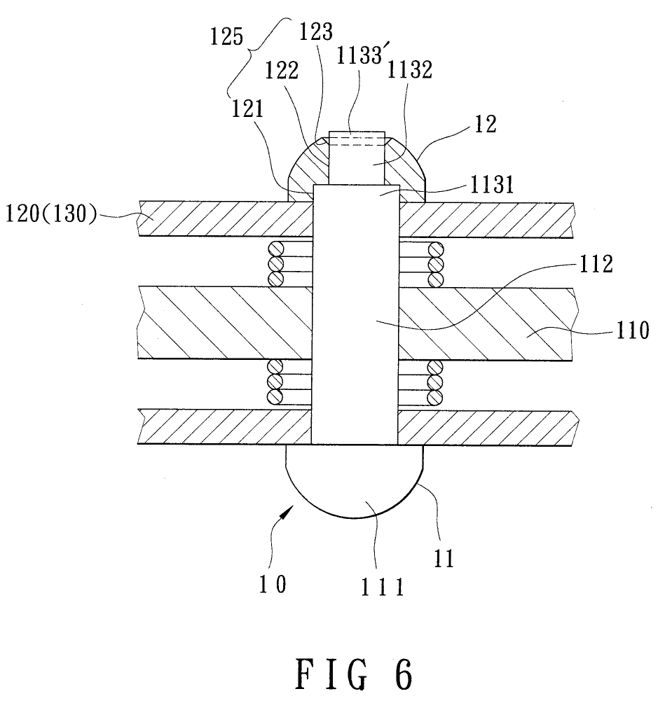

Referring further to FIG. 6, during assembly of each rivet 10, the rod portion 112 of the main body 11 first extends through the corresponding one of the first and second pivot members 120, 130, the hook body 110 and the cover body 12 so that an end 1133′ of the rod portion 112 of the main body 11 extends outwardly of the cover body 12, and the end 1133′ of the rod portion 112 of the main body 11 is then pressed to form the frusto-conical section 1133 of the end portion 113 of the rod portion 112 of the main body 11. It is noted that, since the end 1133′ of the rod portion 112 of the main body 11 of each rivet 10 to be pressed is shorter and thinner as compared to the end 1021 of the rod portion 102 shown in FIG. 2, a smaller pressing force applied to the rod portion 112 of the main body 11 of each rivet 10 during pressing is required, thereby avoiding deformation of the rod portion 112 encountered in the prior art.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. A rivet for connecting pivotally a first member to a second member, said rivet comprising:
a main body having an enlarged head portion, and a rod portion connected integrally to said head portion and adapted to extend through the first and second members, said rod portion having an end portion adapted to extend outwardly of an assembly of the first and second members, said end portion of said rod portion having a thicker section disposed at an end thereof proximate to said head portion, a frusto-conical section disposed at an opposite end thereof, and a thinner section interconnecting said thicker and frusto-conical sections, said thicker section of said end portion of said rod portion having a diameter larger than those of said frusto-conical and thinner sections of said end portion of said rod portion, the diameter of said frusto-conical section of said end portion of said rod portion being not smaller than that of said thinner section of said end portion of said rod portion and decreasing gradually toward said thinner section of said end portion of said rod portion; and
a cover body sleeved fittingly on said end portion of said rod portion of said main body and formed with a through hole permitting extension of said end portion of said rod portion of said main body therethrough so that said frusto-conical section of said end portion of said rod portion of said main body covers said through hole in said cover body, thereby positioning said cover body on the assembly of the first and second members.

2. The rivet as claimed in claim 1, wherein:
said end portion of said rod portion of said main body further has an outer annular shoulder surface disposed between said thicker and thinner sections;
said through hole in said cover body has a wider portion for receiving fittingly said thicker section of said end portion of said rod portion of said main body, a frusto-conical portion for receiving fittingly said frusto-conical section of said end portion of said rod portion of said main body, and a narrower portion for receiving fittingly said thinner section of said end portion of said rod portion of said main body; and
said cover body has an inner annular shoulder surface disposed between said wider and narrower portions of said through hole and abutting against said outer annular shoulder surface of said end portion of said rod portion of said main body.

3. A hanging hook comprising:
a hook body;
a pivot member; and
a rivet for connecting pivotally said pivot member to said hook body so that the pivot member is pivotable relative to the hook body, said rivet including
a main body having an enlarged head portion, and a rod portion connected integrally to said head portion and extending through said hook body and said pivot member, said rod portion having an end portion extending outwardly of an assembly of said hook body and said pivot member, said end portion of said rod portion having a thicker section disposed at one end thereof proximate to said head portion, a frusto-conical section disposed at an opposite end thereof, and a thinner section interconnecting said thicker and frusto-conical sections, said thicker section of said end portion of said rod portion having a diameter larger than those of said frusto-conical and thinner sections of said end portion of said rod portion, the diameter of said frusto-conical section of said end portion of said rod portion being not smaller than that of said thinner section of said end portion of said rod portion and decreasing gradually toward said thinner section of said end portion of said rod portion, and
a cover body sleeved fittingly on said end portion of said rod portion of said main body and formed with a through hole permitting extension of said end portion of said rod portion of said main body therethrough so that said frusto-conical section of said end portion of said rod portion of said main body covers said through hole in said cover body, thereby positioning said cover body on the assembly of said hook body and said pivot member.

4. The hanging hook as claimed in claim 3, wherein:
said end portion of said rod portion of said main body further has an outer annular shoulder surface disposed between said thicker and thinner sections;
said through hole in said cover body has a wider portion for receiving fittingly said thicker section of said end portion of said rod portion of said main body, a frusto-conical portion for receiving fittingly said frusto-conical section of said end portion of said rod portion of said main body, and a narrower portion for receiving fittingly said thinner section of said end portion of said rod portion of said main body; and
said cover body has an inner annular shoulder surface disposed between said wider and narrower portions of said through hole and a butting against said outer annular shoulder surface of said end portion of said rod portion of said main body.
